(19) United States
(12) Patent Application Publication
(10) Pub. No.: US 2016/0180860 A1
(43) Pub. Date: Jun. 23, 2016

(54) High order B-spline sampling rate conversion (SRC)

(71) Applicant: QUALCOMM Incorporated, San Diego, CA (US)

(72) Inventor: Minsheng Wang, Irvine, CA (US)

(21) Appl. No.: 14/757,801

(22) Filed: Dec. 23, 2015

Related U.S. Application Data
(60) Provisional application No. 62/096,401, filed on Dec. 23, 2014.

(51) Int. Cl. G10L 19/06; G10L 19/26; G10L 19/02

(52) U.S. Cl. CPC G10L 19/06; G10L 19/02; G10L 19/26

(57) ABSTRACT

A method for performing a spline interpolation to up-sample audio data includes up-sampling an input audio signal to generate a first signal having a first frequency. The input audio signal is sampled at an input frequency. The method also includes interpolating data of the first signal to generate a second signal having a second frequency. The data of the first signal is interpolated based on a B-spline interpolation function having at least a fourth order. The method includes down-sampling the second signal to generate an output audio signal having an output frequency. The method further includes updating a time index based on an integer operation that is immune to quantization error for a finite-word length implementation.

### I. CLAIM OF PRIORITY

The present application claims priority from U.S. Provisional Patent Application No. 62/096,401, filed Dec. 23, 2014, entitled “HIGH ORDER SPLINE-BASED SAMPLING RATE CONVERSION (SRC),” which is incorporated by reference in its entirety.

### II. FIELD

The present disclosure is generally related to interpolation/decimation or sampling rate conversion (SRC).

### III. DESCRIPTION OF RELATED ART

Advances in technology have resulted in smaller and more powerful computing devices. For example, there currently exist a variety of portable personal computing devices, including wireless computing devices, such as portable wireless telephones, personal digital assistants (PDAs), tablet computers, and paging devices that are small, lightweight, and easily carried by users. Many such computing devices include other devices that are incorporated therein. For example, a wireless telephone can also include a digital still camera, a digital video camera, a digital recorder, and an audio file player. Also, such computing devices can process executable instructions, including software applications, such as a web browser application that can be used to access the Internet and multimedia applications that utilize a still or video camera and provide multimedia playback functionality.

A wireless device may receive input signals (e.g., input audio signals) from an external source. As a non-limiting example, the wireless device may receive input audio signals from a compact disc (CD). The input audio signals from the external source may be sampled at a first frequency that is incompatible with a second frequency of the wireless device. As a non-limiting example, in an audio playback mode, the input audio signals may be sampled at 44.1 kilohertz (kHz), and the wireless device (e.g., a mobile station modem of the wireless device) may have an internal clock domain that operates at 48 kHz or an integer multiple of 48 kHz (e.g., 4.8 megahertz (MHz)). Thus, an interpolation function may be used to up-sample the frequency of the input audio signals to the frequency of the internal clock domain of the wireless device. In the example described above, the input audio signal should be up-sampled by a sampling factor of approximately 1.09 (e.g., 48 kHz/44.1 kHz). In an audio recording mode, the input signal may be sampled at the internal clock domain may operate at a multiple of 48 KHz, and the recorded data is sampled at 44.1 kilohertz (kHz). The input audio signal should be down-sampled by a sampling factor of approximately 0.92 (e.g., 44.1 kHz/48 kHz).

A poly-phase filter may be used to perform the interpolation and decimation function, or sampling rate conversion. For example, four pre-processing filters may up-sample the input audio signals by a factor of sixteen (e.g., each pre-processing filter may up-sample by a factor of two) and may provide the resulting signals to the poly-phase filter. Up-sampling the input audio signal by sixteen may require a large amount of power and a large amount of hardware (e.g., four pre-processing filters). To interpolate data from a first frequency to a second frequency that is a non-integer multiple of the first frequency, the poly-phase filter may calculate a derivative of an input sequence of the resulting signals and a second derivative of the input sequence. For example, the first derivative and the second derivative may be summed and multiplied by the second derivative to generate derivative data. The derivative data may added to the input sequence to generate the interpolated data. Calculating multiple derivatives may be costly. Additionally, the poly-phase filter may include relatively large memories to store information from previous calculations. For example, the poly-phase filter may require approximately 2000 bits of memory storage to generate the interpolated data.

### IV. SUMMARY

Techniques for performing an interpolation function using a spline-based approach are disclosed. An input audio signal having an input sampling frequency (e.g., 44.1 kilohertz (kHz)) may be provided to a receive channel. The receive channel may up-sample the input audio signal to generate an output audio signal having an output sampling frequency (e.g., 48 kHz) that is an integer multiple of a clock frequency (e.g., 4.8 megahertz (MHz)). The receive channel may include pre-processing filters that are configured to up-sample the input audio signal. For example, pre-processing filters may up-sample the input audio signal by a factor of eight (e.g., generating a first signal having a sampling frequency of 352.8 kHz) and may provide the first signal to spline interpolation circuitry in the receive channel. The spline interpolation circuitry may interpolate data values from a first frequency (e.g., 352.8 kHz) to a second frequency (e.g., 1152 kHz) that is a non-integer multiple of the first frequency. The factor at which the spline interpolation circuitry up-samples the first signal may be a non-integer multiple of the ratio of the output sampling frequency to the input sampling frequency

$$( e . g . , \frac{1152 kHz}{352.8 kHz} = 3 * \frac{48 kHz}{44.1 kHz} ) .$$

The spline interpolation circuitry may use a fourth order B-spline interpolation function (e.g., a piecewise spline interpolation function) to interpolate data values from the first frequency to the second frequency. The interpolation may be based on a non-integer up-sampling factor. For example, the sampling rate conversion between the second frequency and the first frequency may be a fractional value

$$( e . g . , 3 * \frac{48 kHz}{44.1 kHz} ) .$$

After interpolation, the resulting signal may be down-sampled by a factor of twenty four to generate the output audio signal having the output sampling frequency. For example, down-sampling by twenty-four may compensate for the pre-processing circuitry up-sampling by eight and for the spline interpolation circuitry up-sampling by the integer multiple (e.g., three) of the ratio

$$( \frac{48 kHz}{44.1 kHz} )$$

such that the receive channel up-samples by the ratio

$$( \frac{48 kHz}{44.1 kHz} ) .$$

Techniques for performing a decimation function using a spline-based approach are disclosed. It is similar to the interpolation, with the only difference that the sampling rate conversion between the second frequency and the first frequency may be a fractional value

$$( e . g . , 3 * \frac{44.1 kHz}{48 kHz} ) .$$

Thus, the conversion from 48 Khz to 44.1 KHz may be achieved.

According to one implementation of the disclosed techniques, a method for performing a spline interpolation to up-sample audio data includes up-sampling an input audio signal to generate a first signal having a first frequency. The input audio signal is sampled at an input frequency. The method also includes interpolating data of the first signal to generate a second signal having a second frequency. The data of the first signal is interpolated based on a B-spline interpolation function having at least a fourth order. The method further includes down-sampling the second signal to generate an output audio signal having an output frequency.

According to another implementation of the disclosed techniques, an apparatus includes pre-processing circuitry configured to up-sample an input audio signal to generate a first signal having a first frequency. The input audio signal is sampled at an input frequency. The apparatus also includes spline interpolation circuitry configured to interpolate data of the first signal to generate, a second signal having a second frequency. The data of the first signal is interpolated based on a B-spline interpolation function having at least a fourth order. The apparatus further includes post-processing circuitry configured to down-sample the second signal to generate an output audio signal having an output frequency.

According to another implementation of the disclosed techniques, a non-transitory computer-readable medium includes instructions for performing a spline interpolation to up-sample audio data. The instructions, when executed by a processor, cause the processor to up-sample an input audio signal to generate a first signal having a first frequency. The input audio signal is sampled at an input frequency. The instructions are also executable to cause the processor to interpolate data of the first signal to generate a second signal having a second frequency. The data of the first signal is interpolated based on a B-spline interpolation function having at least a fourth order. The instructions are further executable to cause the processor to down-sample the second signal to generate an output audio signal having an output frequency.

According to another implementation of the disclosed techniques, an apparatus includes means for up-sampling an input audio signal to generate a first signal having a first frequency. The input audio signal is sampled at an input frequency. The apparatus also includes means for interpolating data of the first signal to generate a second signal having a second frequency. The data of the first signal is interpolated based on a B-spline interpolation function having at least a fourth order. The apparatus further includes means for down-sampling the second signal to generate an output signal having an output frequency.

One particular advantage provided by at least one of the disclosed implementations is an ability to perform an interpolation function using a spline-based approach to reduce the amount of hardware (e.g., pre-processing filters and memory) associated with a poly-phase filter interpolation. For example, poly-phase filter interpolation includes four half-band pre-processing filters to up-sample an input audio signal by a factor of sixteen, while the spline-based approach utilizes three half-band pre-processing filters to up-sample an input audio signal by a factor of eight. Additionally, performing the interpolation function using the spline-based approach may reduce the amount of power consumed and may reduce the cost (e.g., calculation cost) associated with the poly-phase filter interpolation. For example, the extra filter in the poly-phase filter approach may consume a relatively large amount of memory (on the order of a few kilobits to store the FIR coefficients) and its associated power, which are not required by the spline-based approach. Additionally, the spline-based approach does not involve the derivative calculations associated with the poly-phase filter approach. Other aspects, advantages, and features of the present disclosure will become apparent after review of the entire application, including the following sections: Brief Description of the Drawings, Detailed Description, and the Claims.

### V. BRIEF DESCRIPTION OF THE DRAWINGS

FIG. 1 is a diagram of a particular illustrative aspect of a system that includes spline interpolation circuitry configured to interpolate data values;

FIG. 2 illustrates a graph of a piecewise polynomial function used to interpolate data values;

FIG. 3 illustrates another graph of a piecewise polynomial function used to interpolate data values;

FIG. 4A is a flow chart of a particular illustrative aspect of a method for interpolating data values;

FIG. 4B illustrates a first-in-first-out (FIFO) shift register;

FIG. 4C illustrates a flow diagram of logic for updating a buffer read pointer;

FIG. 4D illustrates a flow diagram of logic for calculating a power term for a time index;

FIG. 4E illustrates a flow diagram of logic for calculating spline coefficients; and

FIG. 5 is a block diagram of a device that includes components operable to interpolate data values.

### VI. DETAILED DESCRIPTION

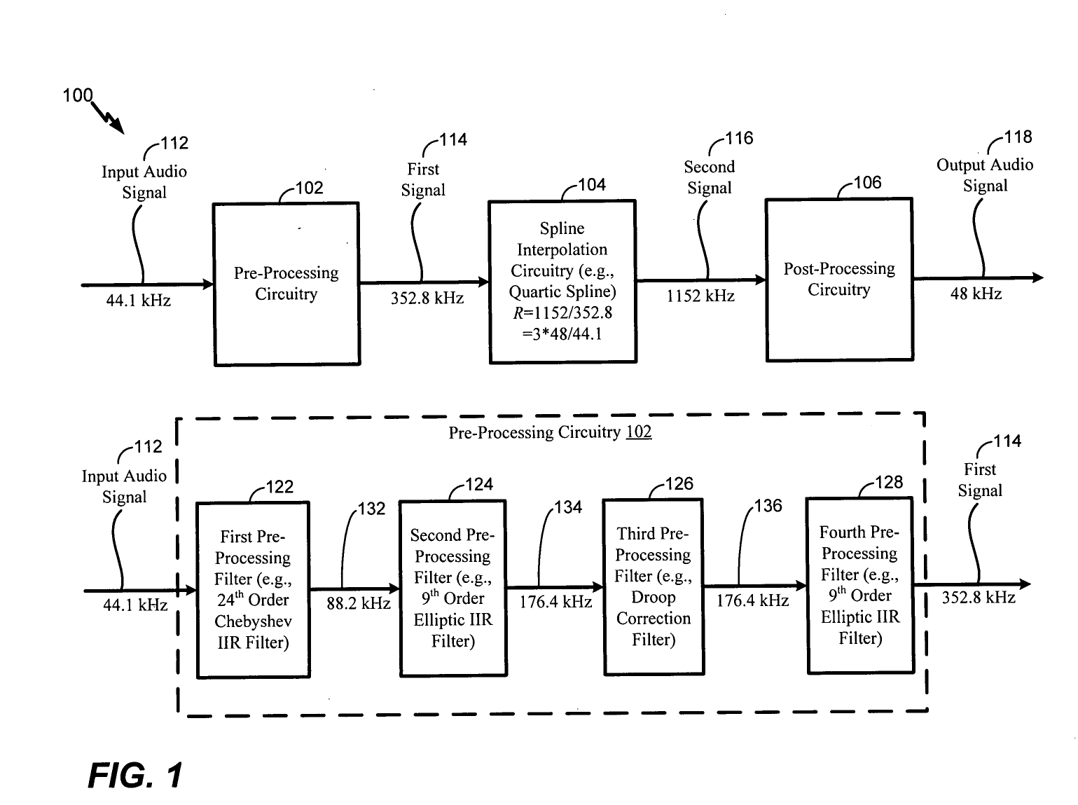

Referring to FIG. 1, a particular illustrative aspect of a system 100 that includes spline interpolation circuitry operable to interpolate data values is shown. The system 100 (e.g., a receive channel) includes pre-processing circuitry 102, spline interpolation circuitry 104, and post-processing circuitry 106. In a particular aspect, the spline interpolation circuitry 104 is operable to perform a high order spline interpolation. For example, the spline interpolation circuitry 104 may be operable to perform a fourth order spline interpolation (e.g., a quartic spline interpolation). The system 100 may be implemented within a mobile phone, a personal digital assistant (PDA), an entertainment unit, a navigation device, a music player, a video player, a digital video player, a digital video disc (DVD) player, or any other device.

The system 100 may be operable to up-sample an input audio signal 112 having an input frequency to generate an output audio signal 118 having an output frequency. As a non-limiting example, the input audio signal 112 may be provided to the system 100 via an external source, such as a compact disc (CD), at a sampling rate of approximately 44.1 kilohertz (kHz). The system 100 may up-sample the input audio signal 112 to generate the output audio signal 118 having a sampling rate of approximately 48 kHz. Thus, in the illustrative example, the system 100 may up-sample the sampling rate at the input audio signal 112 at a non-integer multiple (e.g., approximately 1.09 or 48 kHz/44.1 kHz) to produce the output audio signal 118. The 48 kHz sampling rate of the output audio signal 118 may be up-sampled by an integer multiple to be compatible with a mobile platform (e.g., a mobile station modem of a wireless device operating at 4.8 megahertz (MHz)).

The input audio signal 112 may be provided to the pre-processing circuitry 102, and the pre-processing circuitry 102 may up-sample the input audio signal 112 by a factor of eight to generate a first signal 114 having a sampling frequency of approximately 352.8 kHz (e.g., 8×44.1 kHz). The pre-processing circuitry 102 may include a first pre-processing filter 122, a second pre-processing filter 124, a third pre-processing filter 126, and a fourth pre-processing filter 128.

The first pre-processing filter 122 may be a 24^{th} order Chebyshev infinite impulse response (IIR) filter. The input audio signal 112 may be provided to the first pre-processing filter 122, and the first pre-processing filter 122 may up-sample the input audio signal 112 by a factor of two to generate a signal 132 having a sampling frequency of approximately 88.2 kHz (e.g., 2×44.1 kHz). The signal 132 may be provided to the second pre-processing filter 124.

The second pre-processing filter 124 may be a half-band filter. In a particular aspect, the second pre-processing filter 124 may be a 9^{th} order elliptic IIR filter. The signal 132 may be provided to the second pre-processing filter 124, and the second pre-processing filter 124 may up-sample the signal 132 by a factor of two to generate a signal 134 having a sampling frequency of approximately 176.4 kHz (e.g., 2×88.2 kHz). The signal 134 may be provided to the third pre-processing filter 126. The third pre-processing filter 126 may be a droop correction filter. The third pre-processing filter 126 may be configured to correct distortion at pulses of the signal 134 to generate a signal 136. The signal 136 may be provided to the fourth pre-processing filter 128.

The fourth pre-processing filter 128 may be a half-band filter. In a particular aspect, the fourth pre-processing filter 128 may be a 9^{th} order elliptic IIR filter. The signal 136 may be provided to the fourth pre-processing filter 128, and the fourth pre-processing filter 128 may up-sample the signal 136 by a factor of two to generate the first signal 114 having a sampling frequency of approximately 352.8 kHz (e.g., 2×176.4 kHz). The first signal 144 may be provided to the spline interpolation circuitry 104.

The spline interpolation circuitry 104 may utilize 4^{th} order spline interpolation to interpolate data of the first signal 114 from a first frequency (associated with the first signal 114) to a second frequency of a second signal 116. For example, the spline interpolation circuitry 104 may use a fourth order function y(k) to interpolate data of the first signal 114 from the first frequency (e.g., 352.8 kHz) to the second frequency (e.g., 1152 kHz). The first signal 114 may be expressed as the input signal s(i) to the spline interpolation circuitry 104. The interpolation may be equal to the weighted sum of the input signal s(i). The fourth order function used by the spline interpolation circuitry 104 may be expressed as:

$$y ( k ) = {\sum }_{i ∈ z} s ( i ) * {N}_{4} ( \frac{k}{R} - i ) . \qquad Equation ( 1 )$$

Thus, the fourth order function y(k) may be a piecewise polynomial function. For example, i may be incremented from zero to four, where each increment of i corresponds to a different piece of the piecewise polynomial function. In Equation (1), N₄ is the “base function” of the fourth order function, k is the input value (e.g., time) of the fourth order function, and R is the ratio or sampling rate conversion (SRC) factor at which to interpolate

$$( e . g . , 3 * \frac{48}{44.1} )$$

(e.g., “R” is the rate at which the first signal 114 is up-sampled by the spline interpolation circuitry 104). Thus, the input signal s(i) may be applied to the base function, and Equation (1) may be expanded to Equation (2), such that Equation (2) is expressed as:

$$y ( k ) = s ( 0 ) * e ( \frac{k}{R} ) + s ( 1 ) * d ( \frac{k}{R} ) + s ( 2 ) * c ( \frac{k}{R} ) + s ( 3 ) * b ( \frac{k}{R} ) + s ( 4 ) * a ( \frac{k}{R} ) . \qquad Equation ( 2 )$$

Thus, the fourth order function y(k) includes five terms (e.g., five multiplications). Each term corresponds to a particular piece of the piecewise polynomial function.

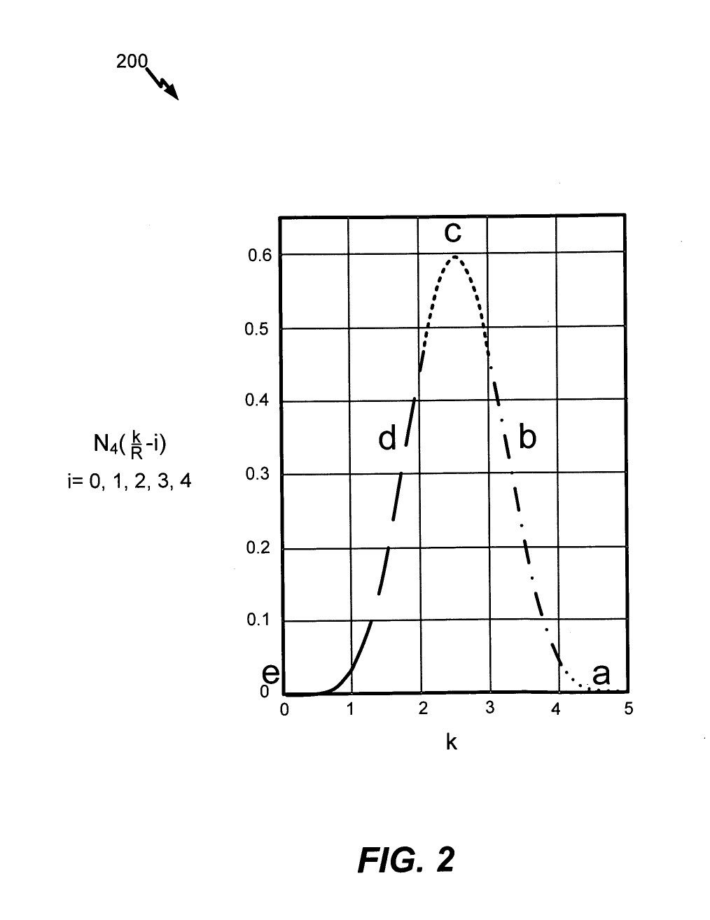

For example, referring to FIG. 2, a particular illustrative aspect of a graph 200 of the piecewise polynomial function is shown. The graph includes a first piece (designated by the letter “a”), a second piece (designated by the letter “b”), a third piece (designated by the letter “c”), a fourth piece (designated by the letter “d”), and a fifth piece (designated by the letter “e”). The first piece of the graph 200 may be represented by the term a

$$( \frac{k}{R} )$$

of Equation (2), the second piece of the graph 200 may be represented by the term b

$$( \frac{k}{R} )$$

of Equation (2), the third piece of the graph 200 may be represented by the term c

$$( \frac{k}{R} )$$

of Equation (2), the fourth piece of the graph 200 may be represented by the term d

$$( \frac{k}{R} )$$

of Equation (2), and the fifth piece of the graph 200 may be represented by the term e

$$( \frac{k}{R} )$$

### of Equation (2).

Each term of Equation (2) may be expanded into individual polynomials. For example, the first term may be expanded to Equation (3), such that Equation (3) is expressed as:

$$( \frac{k}{R} ) * {R}^{4} = {α}_{1} * {k}^{4} + {α}_{2} * ( {k}^{3} * R ) + {α}_{3} * ( {k}^{2} * {R}^{2} ) + {α}_{4} * ( k * {R}^{3} ) + {α}_{5} * {R}^{4} . \qquad Equation ( 3 )$$

Thus, six additional multiplications may be computed when performing the interpolation function. For example, a multiplication for k⁴ may be computed, a multiplication for k³ may be computed, a multiplication for k² may be computed, a multiplication for k³*R may be computed, a multiplication for k²*R² may be computed, and a multiplication for k*R³ may be computed. Thus, the spline interpolation circuitry 104 of FIG. 1 may perform a total of eleven multiplication operations to interpolate from the first frequency to the second frequency. As described above, “R” may be a constant. Thus, for ease of illustration, if “R” is equal to one, Equation (3) may be rewritten as:

α(k)=α₁*k⁴+α₂*k³*+α₃*k²+α₄*k+α₅ Equation (4).

A similar polynomial may be used for each of the remaining terms of Equation (2). In Equation (4), α₁₋₅ are fixed coefficients. The coefficients for α₁₋₅ for the first term of Equation (2) as well as the coefficients for α₁₋₅ for the remaining terms of Equation (2) are listed below in Table 1.

TABLE 1
Coefficients for Piecewise Polynomials

| | a1 | a2 | a3 | a4 | a5 |
|---|---|---|---|---|---|
| a | 0.25 | −1 | 1.5 | −1 | 0.25 |
| b | −1 | 3 | −1.5 | −3 | 2.75 |
| c | 1.5 | −3 | −1.5 | 3 | 2.75 |
| d | −1 | 1 | −1.5 | 1 | 0.25 |
| e | 0.25 | 0 | 0 | 0 | 0 |

Thus, the graph 200 of FIG. 2 illustrates the piecewise polynomial function used by the spline interpolation circuitry 104 to interpolate data values that are up-sampled by a non-integer factor

$$( e . g . , 3 * \frac{48 kHz}{44.1 kHz} ) .$$

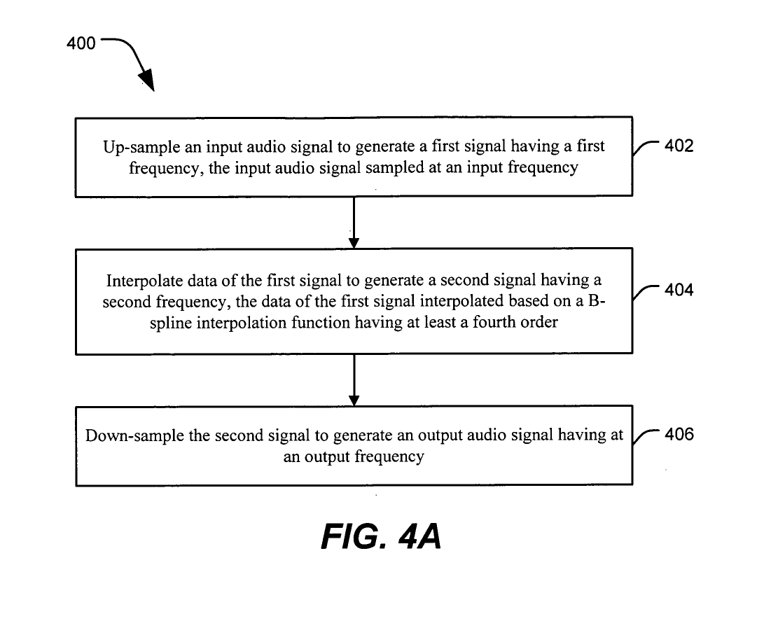

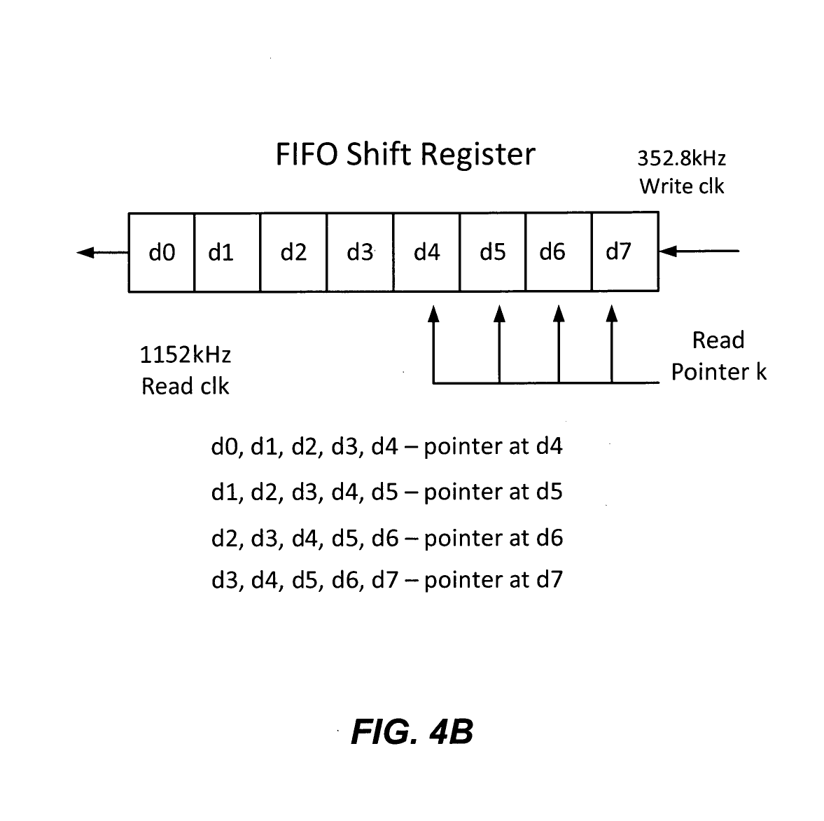

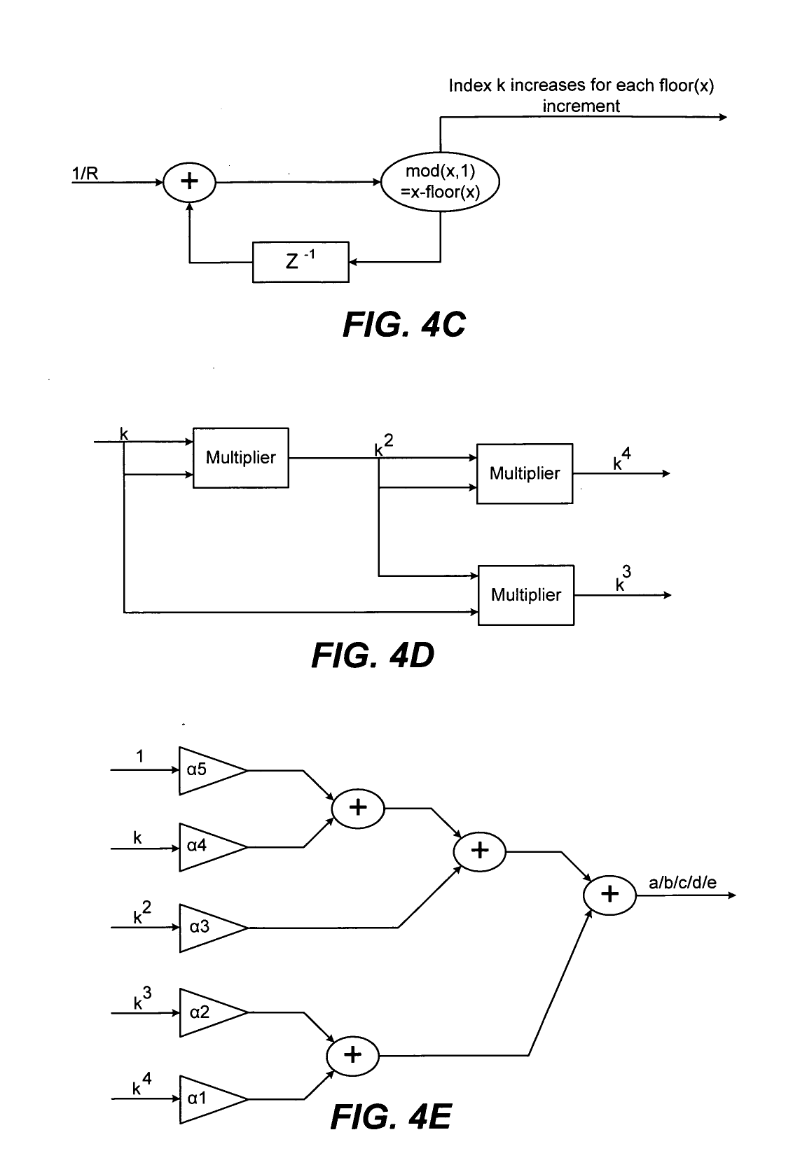

For example, the piecewise polynomial function may be used to interpolate data values from the first frequency (e.g., 352.8 kHz) to the second frequency (e.g., 1152 kHz). FIG. 4E illustrates logic used to calculate the coefficients. The interpolated data values are based on the weighted sum of the signal at any given time instance (k).

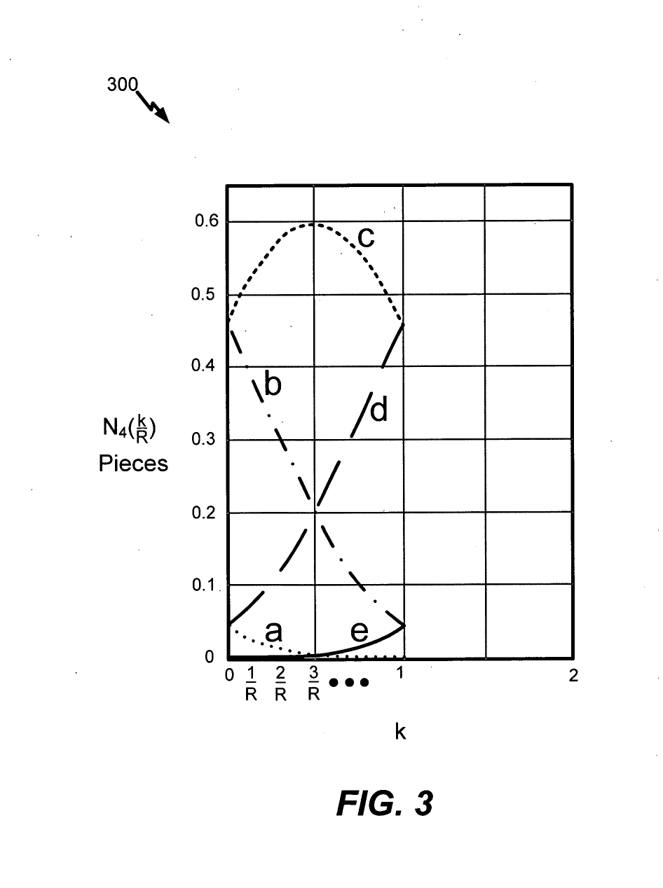

Referring to FIG. 3, another particular illustrative aspect of a graph 300 of the piecewise polynomial function illustrated by the graph 200 of FIG. 2 is shown. As illustrated in the graph 300, each piece (e.g., piece “a” through piece “e”) is shifted to begin at time zero. Thus, the computations for each piece of the piecewise polynomial may be performed in parallel by the spline interpolation circuit 104 of FIG. 1. The interpolated values y(k) for the input signal s(i) may be calculated each at intervals of 1/R along the x-axis. The interpolated values y(k) may be equal to the weighted sum of the input signal s(i).

Thus, the graph 300 of FIG. 3 illustrates that computations for the piecewise polynomial function represented by the graph 200 of FIG. 2 may be performed in parallel. For example, each piece (or segment) of the graph 200 may be shifted to time zero so that calculations for each piece (or segment) of the piecewise polynomial function is calculated in parallel.

Referring back to FIG. 1, the spline interpolation circuitry 104 may use the interpolated values y(k) of the input signal s(i) to generate the second signal 116. For example, the spline interpolation circuitry 104 may use the fourth order function y(k) to up-sample values of the first signal 114 at the 352.8 kHz sampling frequency and generate corresponding values of the second signal 116 at the 1152 kHz sampling frequency. In the illustrative example, the spline interpolation circuitry 104 may up-sample the first signal 114 by a factor (“R”) of approximately 3.265

$$( e . g . , 3 * \frac{48}{44.1} )$$

to generate the second signal 116. The second signal 116 may be provided to the post-processing circuitry 106.

The post-processing circuitry 106 may be a half-band filter. In a particular aspect, the post-processing circuitry 106 may be a 9^{th} order elliptic IIR filter. The second signal 116 may be provided to the post-processing circuitry 106, and the post-processing circuitry 106 may down-sample the second signal 116 by a factor of twenty-four to generate the output audio signal 118 having a sampling frequency of approximately 48 kHz (e.g., 1152 kHz/24).

The system 100 of FIG. 1 may reduce the number of shift operations and add operations used to interpolate data from the first frequency to the second frequency compared to a system that utilizes a poly-phase interpolation. For example, the spline interpolation circuitry may perform eleven multiplication operations to interpolate data. Approximately 4400 shift and add operations may be used to perform the eleven multiplication operations compared to approximately 7440 shift and add operations associated with a poly-phase interpolation. Additionally, the system 100 of FIG. 1 may utilize less memory than a system having a poly-phase interpolation. For example, the spline interpolation circuitry 104 does not require memory to store values from previous interpolations while a poly-phase interpolation may require approximately 2000 bits of storage space to store values from previous interpolations.

The system 100 of FIG. 1 may have a similar performance of a system that utilizes poly-phase interpolation while using less pre-processing hardware. For example, the pre-processing circuitry 102 may include three half-band filters 122, 124, 128 to up-sample the input audio signal 112 by a factor of eight. A system using poly-phase interpolation may require an extra half-band filter to up-sample an input audio signal by sixteen prior to interpolation. The reduced amount of pre-filtering may reduce power consumption and may reduce hardware constraints.

Referring to FIG. 4A, a flowchart of a particular illustrative aspect of a method 400 for performing an interpolation function using a spline-based approach is shown. The method 400 may be performed using the system 100 of FIG. 1.

The method 400 includes up-sampling an input audio signal to generate a first signal having a first frequency, at 402. For example, referring to FIG. 1, the pre-processing circuitry 102 may up-sample the input audio signal 112 by a factor of eight to generate a first signal 114 having a sampling frequency of approximately 352.8 kHz. The input audio signal may be sampled at a 44.1 kHz.

Data of the first signal may be interpolated to generate a second signal having a second frequency, at 404. For example, referring to FIG. 1, the spline interpolation circuitry 104 may utilize 4^{th} order spline interpolation to interpolate data of the first signal 114 from the first frequency (associated with the first signal 114) to the second frequency of the second signal 116. The spline interpolation circuitry 104 may use the interpolated values y(k) of the input signal s(i) (e.g., the first signal 114) to generate the second signal 116. For example, the spline interpolation circuitry 104 may use the fourth order function y(k) to up-sample values of the first signal 114 at the 352.8 kHz sampling frequency and generate corresponding values of the second signal 116 at the 1152 kHz sampling frequency. In the illustrative example, the spline interpolation circuitry 104 may up-sample the first signal 114 by a factor (“R”) of approximately 3.265

$$( e . g . , 3 * \frac{48}{44.1} )$$

to generate the second signal 116. For example, the spline interpolation circuitry 104 may include a filter that is configured to up-sample the first signal by “R”.

A first-in-first-out (FIFO) shift register (e.g., a FIFO buffer) may be used to store the input samples s(0)-s(4) associated with each piecewise polynomial function a

$$( \frac{k}{R} ) - e ( \frac{k}{R} )$$

used to calculate the interpolated value of y(k) in Equation (2). A representative diagram of the FIFO shift register is shown in FIG. 4B. The FIFO shift register may include eight storage elements (e.g., d0-d7). For example, the FIFO buffer may have a buffer size of at least five. Write operations to the FIFO shift register may be performed using the 352.8 kHz write clock. Read operations from the FIFO shift register may be driven by an internal counter based on the 1152 kHz internal clock.

A read pointer updating algorithm may be used if the ratio (R) has infinite precision. For example, if the ratio (R) is expressed as 3*48/44.1=3.265306122448980 . . . with infinite precision (e.g., the ratio is expressed as an infinite decimal), the following logic for updating the buffer read pointer can be used:

k = k+1/R
if (k > 1)

k = k − 1;

end

Referring to FIG. 4C, a flow diagram of logic for updating a buffer read pointer is shown. The time index k increments until it is greater than R=3.265306122448980 . . . , then the index k wraps around by subtracting R from itself. In the real world where every number is represented by a finite-word length, the associated quantization error causes a small error in k each time it subtracts R. This error may accumulate over time, and eventually causes a relatively large error in computing the time index k. The consequence of this accumulated error is that the FIFO buffer either underflows or overflows based on whether the fixed point is greater than or less than the infinite precision. Referring to FIG. 4D, a flow diagram of logic for calculating a power term for the time index (k) is shown. With a fixed bit width of 20 bits assigned for R, the buffer underflow condition may occur once every 5 minutes (331 seconds). If 30 bits are assigned for R, the buffer underflow condition may occur once every 4 days (>90 Hours).

When the ratio (R) is a fixed and rational number (e.g., an integer numerator divided by a non-zero integer denominator), the integer operation can be employed to avoid the overflow and underflow. Specifically, the increment amount and the comparison threshold are both scaled up by a factor of a denominator integer, such as 147. The up-scaled comparison threshold is integer 480 (R*147=3*48/44.1*147=480), and the logic for the buffer read pointer update is the following:

k = k +147
if (k > 480)

k = k − 480;

end

It will be appreciated that the logic has no quantization error because the subtraction is integer based.

Referring back to FIG. 4A, the second signal may be down-sampled to generate an output audio signal having an output frequency, at 406. For example, referring to FIG. 1, the post-processing circuitry 106 may down-sample the second signal 116 by a factor of twenty-four to generate the output audio signal 118 having a sampling frequency of approximately 48 kHz (e.g., 1152 kHz/24).

The method 400 of FIG. 4A may reduce the number of shift operations and add operations used to interpolate data from the first frequency to the second frequency compared to a method that utilizes a poly-phase interpolation. For example, the spline interpolation circuitry may perform eleven multiplication operations to interpolate data. Approximately 4400 shift and add operations may be used to perform the eleven multiplication operations compared to the approximately 7440 shift and add operations associated with a poly-phase interpolation. Additionally, the method 400 may utilize less memory than a system having a poly-phase interpolation. For example, the spline interpolation circuitry 104 does not require memory to store values from previous interpolations while a poly-phase interpolation may require approximately 2000 bits of storage space to store values from previous interpolations.

Performance results of the method 400 may be substantially similar to performance results of a method utilizing poly-phase interpolation while using less pre-processing hardware. For example, the pre-processing circuitry 102 may include three half-band filters 122, 124, 128 to up-sample the input audio signal 112 by a factor of eight. A method utilizing poly-phase interpolation may require an extra half-band filter to up-sample an input audio signal by sixteen prior to interpolation. The reduced amount of pre-filtering may reduce power consumption and may reduce hardware constraints.

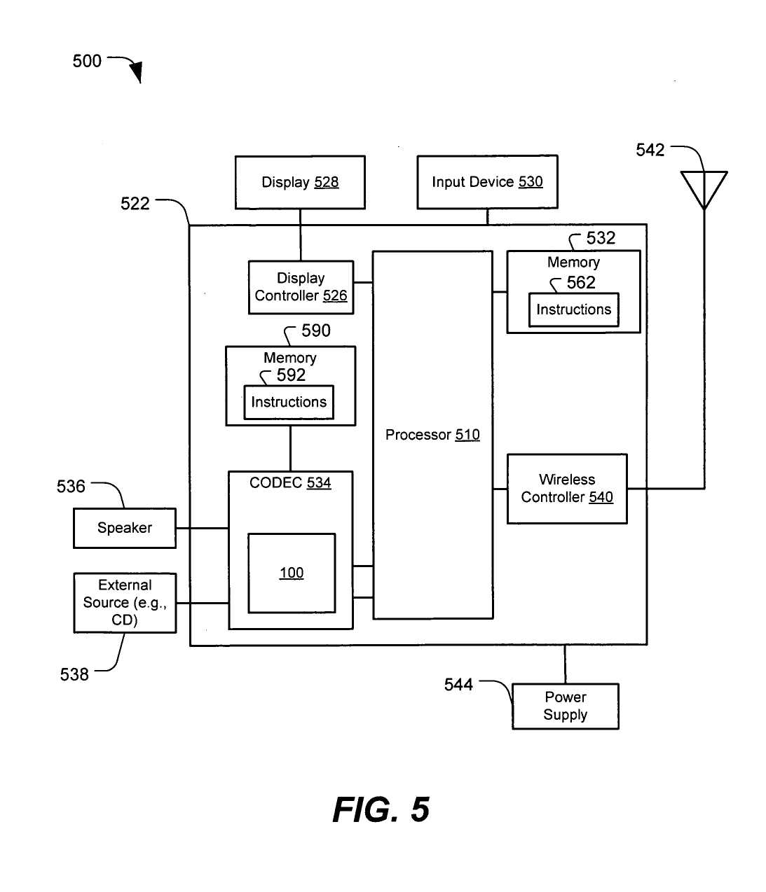

Referring to FIG. 5, a block diagram of a particular illustrative implementation of an electronic device is depicted and generally designated 500. The electronic device 500 includes a processor 510, such as a digital signal processor (DSP) or a central processing unit (CPU), coupled to a memory 532. The memory 532 may be a tangible non-transitory processor-readable storage medium that includes executable instructions 562. In a particular aspect, the instructions 562 may be executed by a processor, such as the processor 510 to perform the method 400 of FIG. 4A.

FIG. 5 also shows a display controller 526 that is coupled to the processor 510 and to a display 528. A coder/decoder (CODEC) 534 can also be coupled to the processor 510. The CODEC 534 may include the system 100 of FIG. 1. A speaker 536 and an external source 538 can be coupled to the CODEC 534. In a particular aspect, the external source 538 may be a compact disc (CD) operating at the first frequency (e.g., 44.1 kHz). The external source 538 may provide the input audio signal 112 to the system 100 implemented within the CODEC 534. The system 100 may be configured to up-sample the input audio signal 112 to generate the output audio signal 118 according to the techniques described with respect to FIG. 1. For example, the system 100 may use spline interpolation circuitry (e.g., the spline interpolation circuitry 104 of FIG. 1) to interpolate data according to the techniques described with respect to FIGS. 1-3. The output audio signal 118 may either be provided to the processor 510 or may be up-sampled at an integer multiple (e.g., up-sampled to 4.8 MHz) and provided to the processor 510. A memory 590 may be coupled to the CODEC 534. In a particular aspect, the memory 590 may be a non-transitory computer-readable medium that includes instructions 592, that when executed by the CODEC 534 (or the system 100 implemented within the CODEC 534), causes the CODEC 534 to perform the method 400 of FIG. 4A. FIG. 5 also indicates that a wireless controller 540 can be coupled to the processor 510 and to an antenna 542.

In a particular aspect, the processor 510, the display controller 526, the memory 532, the CODEC 534, the memory 590, and the wireless controller 540 are included in a system-in-package or system-on-chip device 522. In a particular aspect, an input device 530 and a power supply 544 are coupled to the system-on-chip device 522. Moreover, in a particular aspect, as illustrated in FIG. 5, the display 528, the input device 530, the speaker 536, the external source 538, the antenna 542, and the power supply 544 are external to the system-on-chip device 522. However, each of the display 528, the input device 530, the speaker 536, the external source 538, the antenna 542, and the power supply 544 can be coupled to a component of the system-on-chip device 522, such as an interface or a controller.

In conjunction with the described aspects, an apparatus includes means for up-sampling an input audio signal to generate a first signal having a first frequency. The input audio signal may be sampled at an input frequency. For example, the means for up-sampling the input audio signal may include the pre-processing circuitry 102 of FIG. 1, the first pre-processing filter 122 of FIG. 1, the second pre-processing filter 124 of FIG. 1, the third pre-processing filter 126 of FIG. 1, the fourth pre-processing filter 128 of FIG. 1, the system 100 of FIG. 5, one or more other devices, circuits, modules, or instructions to up-sample the input audio signal, or any combination thereof.

The apparatus may also include means for interpolating data of the first signal to generate a second signal having a second frequency. The data of the first signal may be interpolated based on a B-spline interpolation function. For example, the means for interpolating the data of the first signal may include the spline interpolation circuitry 104 of FIG. 1, the system 100 of FIG. 5, one or more other devices, circuits, modules, or instructions to interpolate the data of the first signal, or any combination thereof.

The apparatus may also include means for down-sampling the second signal to generate an output audio signal having an output frequency. For example, the means for down-sampling the second signal may include the post-processing circuitry 106 of FIG. 1, the system 100 of FIG. 5, one or more other devices, circuits, modules, or instructions to down-sample the second signal, or any combination thereof.

The apparatus may also include means for updating a time index based on an integer operation during interpolation to eliminate overflow conditions and underflow conditions at a first-in-first-out (FIFO) buffer. For example, the means for updating the time index may include the spline interpolation circuitry 104 of FIG. 1, the system 100 of FIG. 5, one or more other devices, circuits, modules, or instructions to update the time index, or any combination thereof.

Those of skill would further appreciate that the various illustrative logical blocks, configurations, modules, circuits, and algorithm steps described in connection with the implementations disclosed herein may be implemented as electronic hardware, computer software, or combinations of both. Various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the implementations disclosed herein may be embodied directly in hardware, in a software module executed by a processor, or in a combination of the two. A software module may reside in random access memory (RAM), flash memory, read-only memory (ROM), programmable read-only memory (PROM), erasable programmable read-only memory (EPROM), electrically erasable programmable read-only memory (EEPROM), registers, hard disk, a removable disk, a compact disc read-only memory (CD-ROM), or any other form of storage medium known in the art. An exemplary non-transitory (e.g. tangible) storage medium is coupled to the processor such that the processor can read information from, and write information to, the storage medium. In the alternative, the storage medium may be integral to the processor. The processor and the storage medium may reside in an application-specific integrated circuit (ASIC). The ASIC may reside in a computing device or a user terminal. In the alternative, the processor and the storage medium may reside as discrete components in a computing device or user terminal.

The previous description of the disclosed implementations is provided to enable a person skilled in the art to make or use the disclosed implementations. Various modifications to these implementations will be readily apparent to those skilled in the art, and the principles defined herein may be applied to other implementations without departing from the scope of the disclosure. Thus, the present disclosure is not intended to be limited to the implementations shown herein but is to be accorded the widest scope possible consistent with the principles and novel features as defined by the following claims.

What is claimed is:

1. A method for performing a spline interpolation to up-sample audio data, the method comprising:
up-sampling an input audio signal to generate a first signal having a first frequency, the input audio signal sampled at an input frequency;
interpolating data of the first signal to generate a second signal having a second frequency, the data of the first signal interpolated based on a B-spline interpolation function having at least a fourth order; and
down-sampling the second signal to generate an output audio signal having an output frequency.

2. The method of claim 1, further comprising updating a time index based on an integer operation during interpolation to eliminate overflow conditions and underflow conditions at a first-in-first-out (FIFO) buffer.

3. The method of claim 1, wherein the B-spline interpolation function includes a piecewise polynomial function.

4. The method of claim 3, wherein interpolating data of the first signal comprises:
applying the piecewise polynomial function to the first signal to determine five data values, each data value associated with a corresponding piece of the piecewise polynomial function; and
summing the five data values to generate interpolated data.

5. The method of claim 4, wherein the five data values are determined in parallel.

6. The method of claim 1, wherein the input frequency is approximately 44.1 kilohertz (kHz), and wherein the output frequency is approximately 48 kHz.

7. The method of claim 1, wherein the input audio signal is up-sampled by a factor of eight.

8. The method of claim 1, wherein the second signal is down-sampled by a factor of twenty-four.

9. An apparatus comprising:
pre-processing circuitry configured to up-sample an input audio signal to generate a first signal having a first frequency, the input audio signal sampled at an input frequency;
spline interpolation circuitry configured to interpolate data of the first signal to generate a second signal having a second frequency, the data of the first signal interpolated based on a B-spline interpolation function having at least a fourth order; and
post-processing circuitry configured to down-sample the second signal to generate an output audio signal having an output frequency.

10. The apparatus of claim 9, wherein a time index is updated based on an integer operation during interpolation to eliminate overflow conditions and underflow conditions at a first-in-first-out (FIFO) buffer.

11. The apparatus of claim 9, wherein the B-spline interpolation function includes a piecewise polynomial function.

12. The apparatus of claim 11, wherein the spline interpolation circuitry is configured to:
apply the piecewise polynomial function to the first signal to determine five data values, each data value associated with a corresponding piece of the piecewise polynomial function; and
sum the five data values to generate interpolated data.

13. The apparatus of claim 12, wherein the five data values are determined in parallel.

14. The apparatus of claim 9, wherein the input frequency is approximately 44.1 kilohertz (kHz), and wherein the output frequency is approximately 48 kHz.

15. The apparatus of claim 9, wherein the input audio signal is up-sampled by a factor of eight.

16. The apparatus of claim 9, wherein the second signal is down-sampled by a factor of twenty-four.

17. A non-transitory computer-readable medium comprising instructions for performing a spline interpolation to up-sample audio data, the instructions, when executed by a processor, cause the processor to:
up-sample an input audio signal to generate a first signal having a first frequency, the input audio signal sampled at an input frequency;
interpolate data of the first signal to generate a second signal having a second frequency, the data of the first signal interpolated based on a B-spline interpolation function having at least a fourth order; and
down-sample the second signal to generate an output audio signal having an output frequency.

18. The non-transitory computer-readable medium of claim 17, wherein a time index is updated based on an integer operation during interpolation to eliminate overflow conditions and underflow conditions at a first-in-first-out (FIFO) buffer.

19. The non-transitory computer-readable medium of claim 17, wherein the B-spline interpolation function includes a piecewise polynomial function.

20. The non-transitory computer-readable medium of claim 19, wherein the instructions are further executable to cause the processor to:
apply the piecewise polynomial function to the first signal to determine five data values, each data value associated with a corresponding piece of the piecewise polynomial function; and
sum of the five data values to generate interpolated data.

21. The non-transitory computer-readable medium of claim 20, wherein the five data values are determined in parallel.

22. The non-transitory computer-readable medium of claim 17, wherein the input frequency is approximately 44.1 kilohertz (kHz), and wherein the output frequency is approximately 48 kHz.

23. The non-transitory computer-readable medium of claim 17, wherein the input audio signal is up-sampled by a factor of eight.

24. The non-transitory computer-readable medium of claim 17, wherein the second signal is down-sampled by a factor of twenty-four.

25. An apparatus comprising:
means for up-sampling an input audio signal to generate a first signal having a first frequency, the input audio signal sampled at an input frequency;
means for interpolating data of the first signal to generate a second signal having a second frequency, the data of the first signal interpolated based on a B-spline interpolation function having at least a fourth order; and
means for down-sampling the second signal to generate an output audio signal having an output frequency.

26. The apparatus of claim 25, further comprising means for updating a time index based on an integer operation during interpolation to eliminate overflow conditions and underflow conditions at a first-in-first-out (FIFO) buffer.

27. The apparatus of claim 25, wherein the B-spline interpolation function includes a piecewise polynomial function.

28. The apparatus of claim 27, wherein interpolating data of the first signal comprises:
applying the piecewise polynomial function to the first signal to determine five data values, each data value associated with a corresponding piece of the piecewise polynomial function; and
summing the five data values to generate interpolated data.

29. The apparatus of claim 28, wherein the five data values are determined in parallel.

30. The apparatus of claim 25, wherein the input frequency is approximately 44.1 kilohertz (kHz), and wherein the output frequency is approximately 48 kHz.
